(19) United States
(12) Patent Application Publication
(10) Pub. No.: US 2026/0303609 A1
(43) Pub. Date: Oct. 1, 2026

(54) HIERARCHICAL DELEGATED PERMISSION SYSTEM FOR COMPLEX ORGANIZATIONS

(71) Applicant: ATLASSIAN PTY LTD, Sydney (AU)

(72) Inventors: Vladimir Churyukin, San Francisco, CA (US); Sidhanta Samantaray, San Francisco, CA (US); Peiyan Zhao, San Francisco, CA (US); Aliaksandr Parfianiuk, San Francisco, CA (US); Satyajit Nath Bhowmik, Agartala (IN)

(21) Appl. No.: 19/096,018

(22) Filed: Mar. 31, 2025

(51) Int. Cl. H04L 9/40

(52) U.S. Cl. CPC H04L 63/105; H04L 63/102

(57) ABSTRACT

Various embodiments are directed to a hierarchical delegated permission system for complex organizations. A hierarchical resource structure comprising a first parent resource hierarchical level corresponding to a first parent resource and one or more child resource hierarchical levels corresponding to one or more child resources may be identified. The first parent resource may be associated with a permissions set. A user addition indication correlated to a group associated with the first parent resource may be received. The user addition indication may be associated with a user profile. A hierarchical role definition set may be dynamically assigned to the user profile based on the hierarchical resource structure and permissions set in response to the user addition indication. The hierarchical role definition set may comprise dynamic role definition credentials for a user associated with the user profile for each of the one or more child resources.

### TECHNICAL FIELD

The present disclosure relates to access control systems; and more particularly to a hierarchical delegated permission system and hierarchical delegated permission modeling framework for managing permissions across complex organizational structures in multi-layer service-oriented platforms

### BACKGROUND

Applicant has identified many deficiencies and problems associated with access control system. Through applied effort, ingenuity, and innovation, these identified deficiencies and problems have been solved by developing solutions that are in accordance with the embodiments of the present invention, many examples of which are described in detail herein.

### SUMMARY

In accordance with one aspect of the present disclosure, a computer-implemented method for configuring a hierarchical delegated permission modeling framework in a multi-layer service-oriented platform is provided. The computer-implemented method may comprise identifying a hierarchical resource structure comprising a first parent resource hierarchical level corresponding to a first parent resource and one or more child resource hierarchical levels corresponding to one or more child resources, wherein the first parent resource is associated with a permissions set; receiving a user addition indication correlated to a group associated with the first parent resource, wherein the user addition indication is associated with a user profile; and dynamically assigning a hierarchical role definition set to the user profile based on the hierarchical resource structure and permissions set in response to the user addition indication, wherein the hierarchical role definition set comprises dynamic role definition credentials for a user associated with the user profile for each of the one or more child resources, and wherein each of the dynamic role definition credentials is associated with a child permissions subset selected from the permissions set.

In some embodiments, the hierarchical role definition set further comprises a parent role definition credential that is different from the dynamic role definition credentials, and wherein the parent role definition credential is associated with permissions data from the permissions set that is different from the child permissions subset for each of the dynamic role definition credentials.

In some embodiments, the parent role definition credential and the dynamic role definition credentials define a hierarchical role structure associated with the hierarchical resource structure, wherein the hierarchical role structure comprises (i) a parent role hierarchical level associated with the parent role definition credential and (ii) one or more child role hierarchical levels associated with the dynamic role definition credentials.

In some embodiments, the first parent resource corresponds to a first software application associated with the multi-layer service-oriented platform.

In some embodiments, the one or more child resource hierarchical levels comprise (i) a first child hierarchical level corresponding to a first child resource of the one or more child resources and (ii) a second child hierarchical level corresponding to a second child resource of the one or more child resources, wherein the first child resource is associated with a first role definition credential from the dynamic role definition credentials and the second child resource is associated with a second role definition credential from the dynamic role definition credentials, and wherein the first role definition credential is different from the second role definition credential.

In some embodiments, the computer-implemented method further comprises receiving user removal indication correlated to the group, wherein the user removal indication is associated with the user profile; and in response to the user removal indication, dynamically unassigning the hierarchical role definition set from the user profile to revoke the child permissions subset associated with the user profile.

In some embodiments, the computer-implemented method further comprises receiving a change event indication correlated to the hierarchical resource structure; and dynamically updating the hierarchical resource structure in response to the change event indication.

In some embodiments, the computer-implemented method further comprises dynamically updating the hierarchical role definition set associated with the user profile based on the change event indication.

In some embodiments, the permissions set is stored in a permissions repository using a denormalized architecture.

In some embodiments, the computer-implemented method further comprises receiving a resource access permission request associated with the user profile, wherein the resource access permission request comprises a user identifier, resource identifier, and permissions type; processing the resource access permission request at least in part by querying the permissions repository for permissions associated with the user for a target resource identified by the resource identifier.

In some embodiments, identifying the hierarchical resource structure comprises receiving the hierarchical resource structure via an API.

In some embodiments, the computer-implemented method further comprises in response to identifying the hierarchical resource structure, configuring the hierarchical resource structure to whitelist the hierarchical resource structure.

In accordance with another aspect of the present disclosure, an apparatus for configuring a hierarchical delegated permission modeling framework in a multi-layer service-oriented platform is provided. In some embodiments, the apparatus comprises at least one processor and at least one memory including program code, the at least one memory and the program code configured to, with the at least one processor, cause the apparatus to at least: identify a hierarchical resource structure comprising a first parent resource hierarchical level corresponding to a first parent resource and one or more child resource hierarchical levels corresponding to one or more child resources, wherein the first parent resource is associated with a group and a parent role definition credential, wherein the parent role definition credential is associated with a permissions set; receive a user addition indication correlated to the group associated with the first parent resource, wherein the user addition indication is associated with a user profile; and dynamically assign a hierarchical role definition set to the user profile based on the hierarchical resource structure and permissions set in response to the user addition indication, wherein the hierarchical role definition set comprises dynamic role definition credentials for a user associated with the user profile for each of the one or more child resources, and wherein each of the dynamic role definition credentials is associated with a child permissions subset that is different from the permissions set.

In some embodiments, the parent role definition credential and the dynamic role definition credentials define a hierarchical role structure associated with the hierarchical resource structure, wherein the hierarchical role structure comprises (i) a parent role hierarchical level associated with the parent role definition credential and (ii) one or more child role hierarchical levels associated with the dynamic role definition credentials,

In some embodiments, the first parent resource corresponds to a first software application associated with the multi-layer service-oriented platform.

In some embodiments, the one or more child resource hierarchical levels comprise (i) a first child hierarchical level corresponding to a first child resource of the one or more child resources and (ii) a second child hierarchical level corresponding to a second child resource of the one or more child resources, wherein the first child resource is associated with a first role definition credential from the dynamic role definition credentials and the second child resource is associated with a second role definition credential from the dynamic role definition credentials, and wherein the first role definition credential is different from the second role definition credential.

In some embodiments, the at least one memory and the program code configured to, with the at least one processor, further cause the apparatus to at least receive user removal indication correlated to the group, wherein the user removal indication is associated with the user profile; and in response to the user removal indication, dynamically unassigning the hierarchical role definition set from the user profile to revoke the child permissions subset associated with the user profile.

In some embodiments, the at least one memory and the program code configured to, with the at least one processor, further cause the apparatus to at least: receive a change event indication correlated to the hierarchical resource structure; and dynamically update the hierarchical resource structure in response to the change event indication.

In some embodiments, the at least one memory and the program code configured to, with the at least one processor, further cause the apparatus to at least dynamically update the hierarchical role definition set associated with the user profile based on the change event indication.

In accordance with another aspect of the present disclosure, at least one non-transitory computer-readable storage medium configuring a hierarchical delegated permission modeling framework in a multi-layer service-oriented platform, the at least one non-transitory computer-readable storage medium having computer coded instructions configured to, when executed by at least one processor: identify a hierarchical resource structure comprising a first parent resource hierarchical level corresponding to a first parent resource and one or more child resource hierarchical levels corresponding to one or more child resources, wherein the first parent resource corresponds to a software application associated with the multi-layer service-oriented platform and is associated with a permissions set; receive a user addition indication correlated to a group associated with the first parent resource, wherein the user addition indication is associated with a user profile; and dynamically assign a hierarchical role definition set to the user profile based on the hierarchical resource structure and permissions set in response to the user addition indication, wherein the hierarchical role definition set comprises parent role definition credential for a user associated with the user profile for the first parent resource and dynamic role definition credentials for each of the one or more child resources, and wherein each of the dynamic role definition credentials is associated with a child permissions subset selected from the permissions set.

### BRIEF DESCRIPTION OF THE SEVERAL VIEWS OF THE DRAWINGS

Having thus described some embodiments in general terms, references will now be made to the accompanying drawings, which are not drawn to scale, and wherein:

FIG. 1 is a block diagram of a system architecture within which at least some embodiments of the present disclosure may operate.

FIG. 2 is a block diagram of an access control and management system in accordance with at least some embodiments of the present disclosure.

FIG. 3 illustrates a sequence diagram for configuring hierarchical resource structures and permissions in accordance with at least some embodiments of the present disclosure.

FIG. 4 illustrates a sequence diagram for managing user additions and removals in an access control and management system in accordance with at least some embodiments of the present disclosure.

FIG. 5 illustrates a sequence diagram for handling resource permissions access requests in accordance with at least some embodiments of the present disclosure.

FIG. 6 illustrates an operational example of a hierarchical resource structure with associated hierarchical role definition structure and permissions in accordance with at least some embodiments of the present disclosure.

FIGS. 7A-7C illustrate block diagrams of various hierarchical role definition structures in accordance with at least some embodiments of the present disclosure.

FIG. 8 illustrates a flowchart of an example process for configuring and managing hierarchical resource permissions in accordance with at least some embodiments of the present disclosure.

FIG. 9 illustrates a flowchart of an example process for handling resource access permissions requests in accordance with at least some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

The present invention addresses a critical challenge in modern software applications and systems, particularly managing permissions across complex, multi-level organizational structures (e.g., complex organization hierarchies). Traditional role-based access control (RBAC) systems often struggle with scalability and adaptability when dealing with ubiquitous complex organizational hierarchies. This limitation has become increasingly problematic as software environments have grown more intricate, with resources and permissions spanning multiple levels of hierarchy.

The current landscape of permission management is characterized by a lack of consistent permission modeling frameworks that can effectively work across all types of hierarchical systems. Organization hierarchies in modern software environments come in various shapes and sizes, from wide but shallow structures to deep and narrow ones. The absence of a unified approach has led to the development of bespoke permission modeling solutions tailored for narrow use cases. These specialized solutions, while effective for their intended purposes, often fail to adapt to all types of hierarchies. Modern software applications and systems require robust permission management systems that can handle the intricacies of ubiquitous complex organizational hierarchies

Existing approaches to this problem have significant limitations. Many current solutions either do not adapt well to all types of hierarchies or require tweaking of RBAC systems to support specific hierarchical structures. This approach of modifying RBAC for particular hierarchies often results in solutions that do not scale effectively. As organization hierarchies and systems grow in complexity and size, these tailored solutions become increasingly difficult to manage and maintain, leading to potential security vulnerabilities and administrative overhead.

Example embodiments of the presented provides a consistent hierarchical delegated permission modeling framework designed to enhance the scalability, flexibility, and manageability of access control in hierarchical systems, including complex organization structure, regardless of the type of hierarchy involved. Example embodiments address these challenges with existing access control systems, by structuring and defining permissions and hierarchies in a manner that can be applied to any type of data, based on an understanding of the nature of the hierarchy involved. This approach provides a unified solution to the challenges posed by complex organizational hierarchies in modern software environments, by offering a scalable and adaptable hierarchical delegated permission modeling framework for permission management across diverse hierarchical structures (e.g., diverse hierarchies).

Various embodiments of the present disclosure, provide a system, method, apparatus, and computer program product for configuring a hierarchical delegated permission modeling framework in various environments, architectures, and platforms including, but not limited to, multi-layer service-oriented platforms. Example embodiments of the present disclosure provide for hierarchical role inheritance, where permissions assigned at a higher level in a hierarchy are automatically cascaded down to child entities. By doing so, example embodiments of the present disclosure ensures that access rights are consistently applied throughout the organizational structure while allowing for exceptions when necessary.

Example embodiments of the present disclosure provide for automatic role assignment by dynamically assigning different roles to user profiles based on predefined configurations and hierarchical structures, including hierarchical resource structures. By doing so, example embodiments, eliminate the need for manual role assignments, reducing administrative overhead and the potential for errors.

Example embodiments of the present disclosure provide for granular definitions of permissions by supporting fine-grained permissions at the resource level in accordance with hierarchal resource structures. By doing so, example embodiments allow for precise control over access rights, ensuring that users have the requisite permissions for their roles, functions, and responsibilities.

Example embodiments of the present disclosure provide for auditability and event processing that allows for tracking (including by other systems) of changes in hierarchies (including organization hierarchies and resource hierarchies/hierarchical resource structures) or permissions to specific resources, enhancing overall system transparency and security. For example, example embodiments operate on an event-driven model, where events representing changes in organization hierarchies (e.g., including group membership), resource hierarchies, or permissions are sent to an event processing service, which in turn, sends the events to an authorization service for processing, allowing for real-time updates to the permission model/structure as changes occur within an organization.

Example embodiments of the present disclosure leverage a permissions repository with a denormalized architecture that allows for quick lookups and permission evaluations (e.g., including evaluations of resource access permission requests) without the need to traverse the entire hierarchy (e.g., such as an entire organization hierarchy or associated resource hierarchy) to evaluate permissions/resource access permission requests. By doing so, example embodiments of the present disclosure ensure fast and accurate processing of resource access permission request.

Example embodiments of the present disclosure provide a versioning mechanism for handling invalidation of permissions efficiently. For example, in response to a change event, such as a user removal event, example embodiments provide techniques that allow for quick invalidation of related permissions across relevant hierarchical resource structures.

Example embodiments of the present disclosure leverage a permissions repository designed to facilitate efficient querying and storage of the complex relationships inherent in the hierarchical model. For example, example embodiments leverage a permissions repository that comprises or implements a relational database management system (such as, for example, Aurora database) that is compatible with MySQL and PostgreSQL. Example embodiments, store permissions in both persistent and cached forms, allowing for quick access to frequently used permission information while ensuring data durability.

In this regard, example embodiments of the present disclosure provide various technical changes and address various deficiencies associated with RBAC system and other conventional access control systems. For example, (i) by using a hierarchical model (e.g., hierarchical delegated permission model), example embodiments provide and implement a permissions model framework that can easily scale to handle large, complex organizational structures without a proportional increase in administrative overhead; (ii) example embodiments provide a permissions model framework that can adapt to various types of hierarchies, from wide and shallow to deep and narrow, without significant reconfiguration; (iii) example embodiments provide for automatic role assignment and permission inheritance that significantly reduce or obviate the need for manual permission management, especially in large organizations; (iv) example embodiments provide improved security by using granular permission control and automatic revocation of permissions when users are removed from groups to maintain a strong security posture; and (v) example embodiments provide a consistent permission modeling framework across different types of hierarchies, which ensures that access control policies are applied uniformly throughout the organization; to name a few.

### DEFINITIONS

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise issue tracking software applications, project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product. In some examples, the application is associated with a multi-layer service-oriented platform.

The term “data object” refers to a data structure, associated with one or more data elements or values in a computer-readable storage medium and/or computer-readable transmission medium, that represents content that is configured for use or display by one or more software applications, services, and/or microservices. A data object may take the structural form of a vector or other appropriate data structure for representing data. A data object may include metadata and may be stored via computer-readable storage medium (e.g., with a repository associated with a server). A data object (or one or mor values thereof) may be transmittable between services, microservices, applications, modules, computing devices, and/or systems by way of a computer-readable transmission medium (e.g., telecommunication signals, wired/wireless electrical signals, and/or the like). In some embodiments, a data object may comprise a plurality of data objects. A data object may be configured to follow a predefined format.

The term “application programming interface” or “API” refer to a computing interface that defines indication inputs between applications, services, microservices, computing devices, repositories, and/or the like of an issue tracking system or a multi-layer service-oriented platform. An application programming interface may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

The term “multi-layer service-oriented platform” refers to a complex network computing environment associated with a multitude of computing devices, applications, services, and microservices. For example, in some embodiments, a multi-layer service-oriented platform includes dozens of applications that are supported by 1000+ services operating within a cloud-based platform. Example multi-layer service-oriented platforms may comprise a federated network of computing devices, and/or a plurality of database platforms (e.g., servers, hard-drives, etc.). Applications and services or microservices of example multi-layer service-oriented platforms may be hosted by internal resources or external resources. Multi-layer service-oriented platforms may support multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given multi-layer service-oriented platform could support hundreds of software applications and hundreds of thousands of features. Those applications and features could be supported by thousands of services and microservices that exist in vast and ever-changing interdependent layers. Software development teams may release code updates that change various software services, launch new software services, change existing features of existing software applications, add new software applications, add new software application features to existing software applications, and/or the like. Non-limiting example of applications and/or tools that may be included in a multi-layer service-oriented platform, include Jira Software® by Atlassian, Inc. Jira Service Management® by Atlassian Inc., Confluence® by Atlassian, Inc., JIRA Service Desk by Atlassian®., Inc., Loom® video messaging, and Trello®.

In some embodiments, the term “resource” refers to an entity, such as a software entity, configured to provide one or more functionalities within a multi-layer service-oriented platform. A resource may comprise a software program, application, platform, or service that is designed to offer specific capabilities to other components or entities within or associated with an application or a multi-layer service-oriented platform. These functionalities may be provided either directly or indirectly to other software programs, platforms, or services operating on the multi-layer service-oriented platform. In some examples, resources encapsulate specific logic, data processing capabilities, or service interfaces within an application or multi-layer service-oriented platform. Non-limiting examples of a resource include an application, an organization, an entitlement, a service, and/or the like. A resource may be associated with a unique identifier, such as a Uniform Resource Identifier (URI) or other identifier, which may enable other components in the system to locate and interact with the resource. In some examples, resources are managed by a resource management system/component within a multi-layer service-oriented platform, which may utilize a distributed database to store metadata about each resource, including its current state, version, and/or permissions. In some examples, such database may be implemented using techniques configured to provide high availability and scalability across the distributed computing environment. In some examples, a resource is associated with predefined permissions, which may be configured and/or enforced by an access control and management system to ensure authorized entity interactions with the resource. In some examples, the functionality of a resource may be exposed through one or more APIs, which, for example, may follow RESTful principles or utilize other protocols for efficient communication. The API(s) may allow other components in the multi-layer service-oriented platform to interact with the resource, request data, or trigger specific actions.

The term “internal resource” refers to a software program, application, platform, or service that is configured by an organization (e.g., an enterprise owner of a multi-layer service-oriented platform) to provide functionality to another one or more of the software programs, applications, platforms, or services operating on a multi-layer service-oriented platform, either directly or indirectly, through one or more other services. Internal resources operate on a compiled code base and/or use data repositories that are at least partially shared by other software programs, applications, or services of the multi-layer service-oriented platform. In some embodiments, application code bases, service code bases, and code bases that support an internal resource are hosted on common servers or using computing devices operating within a common intranet or network.

The term “external resource” refers to a software program, application, platform, or service that is configured to communicate with applications, services, software programs, and/or devices of a multi-layer service-oriented platform but which operates on a compiled code base that is separate from code bases of the multi-layer service-oriented platform. In some embodiments, communications between an external resource and an application or service calling the external resource takes place through a firewall and/or other network security features of the multi-layer service-oriented platform. The external resource operates on a compiled code base or repository that is separate and distinct from that which supports the application or service of the multi-layer service-oriented platform calling the external resource. The external resource is generally considered outside of the ecosystem of internal resources that are generated, operated, maintained, and controlled by developers of the multi-layer service-oriented platform.

The term “entitlement” refers to a resource that represents and manages entitlements within an application or a multi-layer service-oriented platform. By way of example, entitlement may encapsulate the details and functionality related to an entity's access rights to software application products or services, including information such as support levels, product tiers, license quantities, expiration dates. Entitlement may be used to control and manage access to various software applications products and services within the multi-layer service-oriented platform. An entitlement may be associated with a schema that defines the structure of entitlement records, including fields for entity identifiers (e.g., user identifiers or the like), access levels, temporal data, and/or the like. In some examples, entitlement may be implemented as a data structure within a distributed database system, which may allow for efficient storage and retrieval of entitlement data across a scalable infrastructure. In some examples, entitlement may be managed by a dedicated microservice within a multi-layer service-oriented platform.

The term “role” refers to a mechanism for assigning permissions to users or user groups within a system. Such system may be an organization system. A role may correspond to a collection of access rights/permissions and/or responsibilities that may be granted to entities, allowing for efficient management of permissions across multiple users with similar functions or levels of authority. For example, roles may be used to abstract and/or simplify the process of assigning permissions to entities. Such entities may include, but not limited to, computing entities, services, microservices, users, or user groups. By way of example, techniques described herein provide for role definitions based at least in part on user input such as input from administrators of an organization, where the roles encompass or are otherwise associated with permissions relevant to specific functions, levels of responsibility, levels of authority, and/or the like. By doing so, techniques described herein obviate the need for a user administrator or other agents to manually specify permissions for each entity individually. In some examples, roles may be implemented as objects that encapsulate permissions datasets or access control lists (ACLs). In some examples, the management of roles may be handled using improved role-based access control (RBAC) techniques. In some examples, the functionality associated with or facilitated by roles include operations for creating and modifying role definitions, assigning roles to users or groups, and evaluating effective permissions based on assigned roles. For example, roles may be leveraged to facilitate methods for hierarchical role inheritance, where more specialized roles may inherit permissions from more general roles and/or add additional specific permissions. In some examples, such specialized roles correspond to child roles in a role hierarchy defined by a hierarchical role structure associated with one or more applications or multi-layer service-oriented platform.

The term “hierarchical resource structure” refers to a data structure configured to represents relationships between resources associated with one or more applications (which may be associated with a multi-layer service-oriented platform). For example, a hierarchical resource structure may be used to model complex relationships between different resources associated with one or more applications. In some examples, such relationships include dependency relationships. For example, a first resource may be dependent on a second resource. Alternatively, or additionally, in some examples, such relationships refer to exchange of data or functionality between resources (e.g., between a first resource and a second resource). In some examples, the hierarchical resource structure organizes the resources in a tree-like arrangement, establishing parent-child relationships between the resources. The resources may be represented by nodes of the hierarchical resource structure and the relationships between resources may be represented by edges of the hierarchical resource structure connecting resources together. A hierarchical resource structure allows and may be leveraged to facilitate delegated permission models (e.g., according to techniques described herein) that provide for hierarchical role inheritance, automatic role assignments, granular permission definitions, and/or audibility and event-driven functionalities. For example, a hierarchical role definition structure may be defined based at least in part on a hierarchical resource structure, wherein the hierarchical role definition structure and may be queried, traversed, or otherwise leveraged to handle permissions configurations and access permission requests. The functionalities associated with or facilitated by a hierarchical resource structure may include operations such as, but not limited to, adding or removing nodes, moving subtrees, or traversing the hierarchical resource structure to assign resource roles, unassign roles, retrieve specific resources, and/or the like. In some examples, the hierarchical resource structure provides capabilities for versioning and tracking changes to the hierarchy (e.g., defined by the hierarchical resource structure) over time. In some examples, such versioning capabilities are implemented using event sourcing techniques, where each modification to the hierarchical resource structure is recorded as an immutable event, allowing for auditing and reconstruction of the hierarchical resource structure. A hierarchical resource structure may be designed to support dynamic restructuring, where the parent-child relationships may be modified based on certain conditions or events.

The term “parent resource hierarchical level” refers to a node within a hierarchical resource structure with one or more child nodes below it. A parent resource hierarchical level may represent or correspond to a higher-level resource in the hierarchy that encompasses and/or influences its child resources. In some examples, a parent resource hierarchical level is used to organize and categorize resources. A parent resource hierarchical level may serve as a container for child resources and/or may represent a broader grouping. For example, in an example hierarchical resource structure associated with a collaboration application such as Confluence by Atlassian®, an example parent resource hierarchical level may represent a workspace and may include multiple child resource hierarchical levels representing pages. In some examples, a parent resource hierarchical level is implemented as a node object within a hierarchical resource structure. Such implementation may utilize object-oriented programming techniques, with each parent resource hierarchical level (e.g., parent node) comprising references to the corresponding child nodes. In some examples, a parent resource hierarchical level may maintain metadata such as depth in the tree, number of children, or aggregated properties derived from its subtree. In some examples, the functionality associated with or facilitated by a parent resource hierarchical level may include operations for adding or removing child nodes, querying child resources, and propagating changes or permissions down the hierarchy defined by the hierarchical resource structure.

The term “parent resource” refers to a resource corresponding to a parent resource hierarchical level within a hierarchical resource structure. A parent resource may represent a higher-level entity that encompasses and may govern the behavior or properties of its associated child resources. For example, parent resources may be used to model high-level entities within or associated with a system and may represent broader categories or container-like structures that group related child resources. One or more techniques may be leveraged to dynamically associate child resources with their parent resources. Such techniques may be configured to allow for flexible composition and decomposition of hierarchical resource structures. Changes or events may be propagated from parent resources to their child resources. The functionality associated with or facilitated by a parent resource may include, but not limited to, operations for defining and assigning roles, defining and assigning permissions, and/or managing corresponding child resources, such as adding, removing, or reordering child resources. In some examples, parent resources include support for hierarchical role inheritance, where permissions associated with a corresponding parent role may be dynamically cascaded to child entities/child resources unless explicitly overridden.

The term “child resource hierarchical level” refers to a node within a hierarchical resource structure that is connected to and subordinate to a parent node. In some examples, a child resource hierarchical level may represent more specific or granular resources in the hierarchical resource structure that inherit properties and/or is influenced by the parent resource. In some examples, a child resource hierarchical level is implemented as a node object within a hierarchical resource structure. In some examples, such implementation may utilize techniques that allow different types of child resources to exist within the same hierarchical resource structure. The functionality associated with or facilitated by child resource hierarchical levels may include, but not limited to, operations for accessing parent resources, sibling resources, or descendant resources. Child resource hierarchical levels may include support for multi-parent relationships, allowing a child resource to belong to multiple hierarchies simultaneously.

The term “child resource” refers to a resource corresponding to a child resource hierarchical level within a hierarchical resource structure. A child resource may represent a more specific or granular resource that is subordinate to and may inherit properties or behaviors from its parent resource. For example, child resources may be used to represent more detailed or specific resources within the hierarchical resource structure and may inherit certain attributes, permissions, or constraints from their parent resources while having additional properties or behaviors specific to their level of granularity. The functionality associated with or facilitated by a child resource may include operations for accessing its parent resource, sibling resources, or its own child resources if it serves as an intermediate node in the hierarchy. In some examples, child resources may include support for multiple inheritance, allowing a child resource to derive properties or behaviors from multiple parent resources.

The term “permissions set”, “permissions dataset”, “permissions data” refers to a collection of permissions (e.g., permission credentials) that control the access and/or level of access an entity has to a resource. A permissions set may define the specific actions or operations that are allowed or restricted for a given user or role with respect to a one or more resources. Permissions sets may be used to enforce access control policies within an application or across multiple applications (which may be associated with a multi-layer service-oriented platform). For example, a permissions set may comprise permissions that determine what actions an entity (e.g., a user, a computing entity, a service, or the like) is authorized to perform, what data the entity may access, and/or what features of an application the entity may use. By way of example, in a project management application/platform, permission sets may control whether a user can create tasks, assign work to others, or view information associated with a project. As another example, in a content management application/platform, a permissions set may include flags for read, write, delete, and share operations on different types of content. A permissions set may be implemented as data structures, algorithms, or combination of data structures and algorithms designed for efficient storage, retrieval, and evaluation of access rights, including evaluation of resource access permission requests. The functionality associated with or facilitated by a permissions set may include, but not limited to, operations for adding or removing individual permissions, checking if a specific permission is granted, and/or combining or intersecting multiple permissions sets. In some examples, permissions sets may provide for methods for serializing the permissions set for storage or transmission, and deserializing for use in runtime permission checks. In some examples, the management of permissions may be facilitated by an authorization service within access control and management system, as described herein. In some examples, such authorization service may implement role-based access control techniques (RBAC), policy-based access control (PBAC) techniques, and/or other access control techniques.

The term “child permissions subset” refers to at least a portion of a permissions set associated with a parent resource. A child permissions subset may define the specific actions, operations, or access rights granted to entities or associated roles with respect to one or more resources. A child permissions subset may comprise a subset of a permissions set associated with a parent resource from a hierarchical resource structure that is dynamically assigned to a user group or user profile associated with an entity based at least in part on a hierarchical resource definition structure associated with the hierarchical resource structure. For example, a child permissions subset may represent a more specific or limited set of access rights/permissions for a role associated with a child resource that is derived from or influenced by the permissions of its parent resource.

The term “user group”, “group” or similar terms refer to a collection of users who share similar characteristics, roles, and/or functions within a system. A user group may serve as a mechanism for organizing users (or other entities) and applying collective permissions to multiple users simultaneously. User group may be leveraged according to techniques described herein to improve the management of permissions across users. In some examples, a user group may be implemented as a data structure (e.g., which may be a hierarchical group structure) that maintains associations between group identifiers and/or collections of user identifiers. User groups may provide for nested group structures, allowing for hierarchical organization of users and inheritance of group properties. These functions may be implemented using role-based access control (RBAC) models for mapping groups to permissions. User groups may allow for bulk assignment of access rights, role assignments, permissions, configuration settings, and/or the like. The functionality associated with or facilitated by user groups may include, but not limited to, operations for creating and deleting groups, adding or removing users from groups, and/or querying group memberships.

The term “user addition indication” refers to a signal, data, message (e.g., an inter-service message, intra-service message, network message, etc.), or computer readable instructions that describe an indication of a user addition event. A user addition event may occur when a user is added to a user group (also referred to herein as group) linked or otherwise associated with a hierarchical resource structure. In some examples, a user addition indication may be implemented as an event object within an event-driven architecture. Such implementation may utilize message queues or publish-subscribe patterns to propagate the user addition event across different components of one or more applications or system. The event object may comprise metadata such as timestamps, user identifiers, group identifiers, and the source of the user addition event. For example, a user addition indication may represent the notification or record of a new user being added as a member of a specific user group. A user addition indication may trigger one or more actions including, but not limited to, assigning a hierarchical role definition set to a user profile identified by the user addition indication. The processing of user addition events and/or user addition indications may be managed by an event processing service within the system architecture. Such event processing service may employ stream processing frameworks to handle high-volume user addition events in real-time.

The term “user removal indication” refers to a signal, data, message (e.g., an inter-service message, intra-service message, network message, etc.), or computer readable instructions that describe an indication of a user removal event. A user removal event may occur when a user is removed from a user group that is linked or otherwise associated with a hierarchical resource structure. In some examples, a user removal event may be implemented as an event object within an event-driven architecture. Such implementation may utilize message queues or publish-subscribe patterns to propagate the user removal event across different components of one or more applications or system. The event object may comprise metadata such as timestamps, user identifiers, group identifiers, and the source of the user removal event. For example, a user removal indication may represent the notification or record of a user being removed as a member of a specific user group. A user removal indication may trigger one or more actions including, but not limited to, unassigning a hierarchical role definition set that is previously assigned to a user profile identified by the user removal indication to invalidate related permissions across the hierarchy. The processing of user removal events and/or user removal indications may be managed by an event processing service within the system architecture. Such event processing service may employ stream processing frameworks to handle high-volume user removal events in real-time.

The term “user profile” refers to a data entity that describes a collection of information about a user. A user profile may encapsulate various attributes, settings, and/or preferences associated with a specific user account. For example, a user profile may be used as a central repository of user-specific information that informs various aspects of the system's behavior. In some examples, a user profile may be implemented as a structured data object, which may be stored in a database or directory service. Such implementation may utilize object-relational mapping (ORM) techniques for relational databases, document-based storage for NoSQL databases, or the like. A user profile may be associated with a user profile schema that may include fields for basic information, security credentials, role assignments, and/or customizable attributes specific to the application domain.

The term “group identifier” refers to one or more items or elements by which a group may be uniquely identified from other groups. The group identifier may be in the form of text string(s), numerical character(s), alphabetical character(s), alphanumeric code(s), American Standard Code for information Interchange (ASCII) characters(s), and/or the like.

The term “user identifier” refers to one or more items or elements by which a user may be uniquely identified from other users. The user identifier may be in the form of text string(s), numerical character(s), alphabetical character(s), alphanumeric code(s), American Standard Code for information Interchange (ASCII) characters(s), and/or the like.

The term “resource identifier” refers to one or more items or elements by which a resource may be uniquely identified from other users. The resource identifier may be in the form of text string(s), numerical character(s), alphabetical character(s), alphanumeric code(s), American Standard Code for information Interchange (ASCII) characters(s), and/or the like.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

Methods, apparatuses, and computer program products of the present disclosure may be embodied by any of a variety of devices. For example, the method, apparatus, and computer program product of an example embodiment may be embodied by a networked device (e.g., a federated software platform, or the like), such as a server or other network entity, configured to communicate with one or more devices, such as one or more query-initiating computing devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

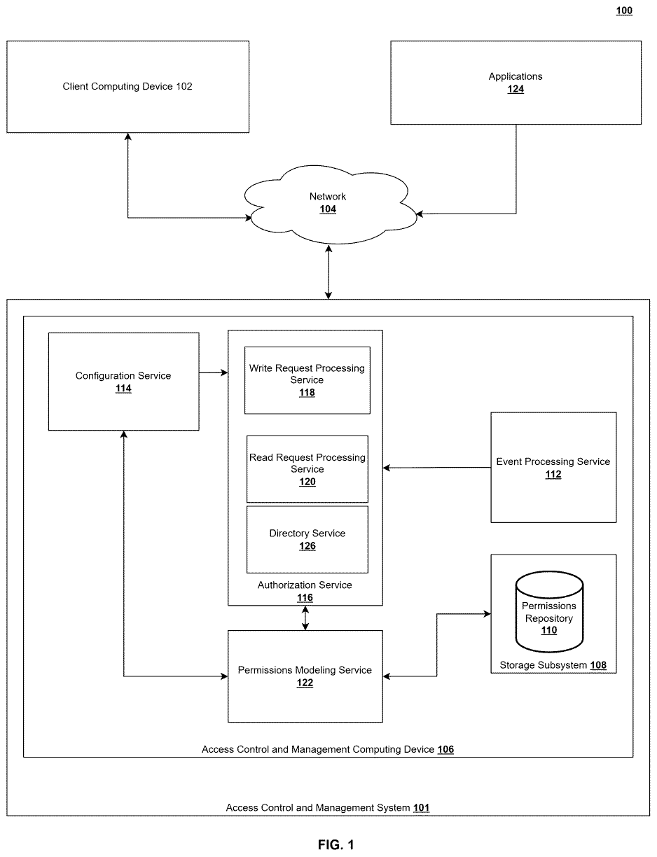

In this regard, FIG. 1 shows an example system architecture 100 within which embodiments of the present disclosure may operate. The depiction of the example system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, and/or add aspects and/or components.

As shown in FIG. 1 the system architecture 100 includes an access control and management system 101 (e.g., hierarchical delegated permission system). The access control and management system 101 may be or comprise services, microservices, a platform, and/or a software application that is configured for execution via one or more computing devices. The one or more computing devices and its associated components facilitate the configuring, execution, and management of access controls in various contexts and domains.

For example, the access control and management system 101 implements a hierarchical delegated permission modeling framework designed to enhance scalability, flexibility, and manageability of access control in hierarchical systems, regardless of the type of hierarchy involved. In various embodiments, the hierarchical delegated permission modeling framework comprises structuring and defining permissions and hierarchies in a manner that can be applied to various types of data.

The access control and management system 101 and hierarchical delegated permission modeling framework thereof has wide-ranging applications across various industries and organization types. Non-limiting examples of such industries and organization types include large enterprises/companies with complex organizational structures and multiple subsidiaries or departments that may benefit from the system's ability to manage permissions across different levels of hierarchy; cloud service providers with multi-tenant cloud environments (e.g., where different customers may have varying hierarchical structures including varying organizational structures) may leverage the access control and management system 101 to effectively and efficiently manage permissions in such multi-tenant cloud environments; healthcare organizations with strict privacy regulations and complex organizational structures may leverage the access control and management system 101 to ensure proper access control to sensitive patient information across different departments and roles; government agencies with multiple departments and security clearance levels may leverage the ability of the access control and management system 101 to handle complex hierarchies and provide detailed auditing; and educational institutions (e.g., universities and school systems) with multiple campuses, departments, and user types (students, faculty, staff) may benefit from the hierarchical delegated permission modeling framework implemented by the access control and management system 101.

The access control and management system 101 may communicate with one or more client computing devices 102 and one or more applications 124 through a network 104. In some examples, the one or more applications may be associated with a multi-layer service-oriented platform. The access control and management system 101 provides various capabilities and functionalities including, but not limited to, hierarchical role inheritance configured to cascade permissions assigned at a higher level in hierarchical delegated permission modeling framework to child entities (e.g., unless explicitly overridden); automatic role assignment configured to dynamically assign different roles to user profiles based on hierarchical structure(s) defined by the hierarchical delegated permission modeling framework (e.g., and predefined configurations in some examples); granular permission definitions configured to support fine-grained permissions at the resource level in accordance with the hierarchy, auditability, and event processing configured to provide triggering, tracking, and handling of change events, including changes in hierarchies or permissions for accessing specific resources.

In some embodiments, the functions of one or more of the illustrated components in FIG. 1 may be performed by a single computing device or by multiple computing devices, which devices may be local or cloud based. It will be appreciated that the various functions performed by the access control and management system 101 (or portion thereof), the one or more client computing devices 102, the one or more applications 124 and/or the various functions performed by the components of the access control and management system 101 may be embodied by a single apparatus, subsystem, or system comprising one or more sets of computing hardware (e.g., processor(s) and memory) configured to perform the various functions thereof. In some embodiments, one or more components of the access control and management system 101 may be embodied by a client computing device 102.

In various embodiments, the access control and management system 101 includes an access control and management computing device 106. The access control and management computing device 106 is configured to perform various functionalities associated with the access control and management system 101 including, but not limited to, structuring and defining permissions and hierarchies/hierarchical structures such as hierarchical resource structures and hierarchical role definition structures in accordance with a hierarchical delegated permission modeling framework, as described herein. In some embodiments, the access control and management computing device 106 comprise at least one processor and at least one memory including program code. Alternatively, or additionally, in some cases, the access control and management computing device 106 may include multiple interconnected services.

As shown in FIG. 1, the access control and management computing device 106 may include a configuration service 114, an authorization service 116, and a permissions modeling service 122. Additionally, in some embodiments, the access control and management computing device 106 may include a directory service 126. The directory service 116 may be configured to perform one or more functions associated with the access control and management computing device 106 including, but not limited to, transmitting user addition indications and/or user removal indications according to at least some embodiments of the present disclosure. The configuration service 114 may be configured to perform one or more functionalities associated with the hierarchical delegated permission modeling framework, including structuring and defining permissions and hierarchical structures (e.g., hierarchical resource structures and hierarchical resource definition structures). In various embodiments, the configuration service 114 is configured to perform a whitelisting process designed to whitelist hierarchical resource structures (or underlying data) such that events associated with hierarchical resource structures that are not whitelisted may not be ingested by the system 101 for processing.

The authorization service 116 may include a write request processing service 118, and read request processing service 120, configured to perform various functions associated with the authorization service 116 and/or the access control and management system 101 as described herein. For example, the authorization service 116 may be configured to manage or direct the write request processing service 118 and read request processing service 120. The configuration service 114 may be communicatively coupled with the write request processing service 118 and/or the read request processing service 120. In various embodiments, the configuration service may leverage the write request processing service 118 and/or the read request processing service 120 to facilitate one or more functionalities associated with the configuration service 114.

In various embodiments, the write request processing service 118 is configured to handle write operations associated with the authorization service. Additionally, the write request processing service 118 may be configured to handle write operations associated with other components of the access control and management computing device 106 or access control and management system 101. A non-limiting example of such write operation that the write request processing service 118 is configured to perform includes writing changes to hierarchical structures such as hierarchical resource structures, hierarchical role definition structures, and hierarchical organization structures (including writing changes to user group memberships). For example, the write request processing service 118 may be configured to receive write requests (e.g., requests to modify hierarchical resource structures, user group memberships, or permissions) and process the write requests. In some examples, processing the write request (e.g., such as writing changes to hierarchical structures, group memberships, or permissions) include updating the corresponding hierarchical structures (or underlying data) within a storage location such as storage subsystem 108 (or permissions repository 110 thereof) as further described herein. By way of example, updating a hierarchical structure may comprise adding, deleting and/or modifying nodes and/or edges of the hierarchical structure (e.g., adding, deleting, and/or modifying resources, relationships between resources, roles, relationships between roles, groups, group members (e.g., users associated with a group, and/or the like within the hierarchical structure). In some embodiments, the write request processing service 118 may be configured to processes these change event received via an event processing service such as event processing service 112 (described further below) and update the permissions repository 110 (e.g., corresponding data stores therein).

In various embodiments, the read request processing service 120 is configured to handle read operations associated with the authorization service 116. Additionally, the read request processing service 120 may be configured to handle read operations associated with other components of the access control and management computing device 106 or access control and management system 101. A non-limiting example of such read operation that the read request processing service 120 is configured to perform includes accessing and retrieving data and/or objects stored in a storage location such as hierarchical resource structures, hierarchical role definition structures, and/or permissions. The read request processing service may be configured to receive resource access permission request and process the resource access permission requests to determine if a user profile identified by the resource access permission request possesses or is otherwise associated with the requisite permissions for the resource access requested in the resource access permission request. For example, the read request processing service may be configured to evaluate permissions within a permissions repository 110 to determine if a user profile is associated the requisite permissions for a resource and provide a response to a client computing device 102 and/or application 124, directly or indirectly. In various embodiments, the read request processing service is configured to operate at a high level of accuracy without introducing significant latency to the system.

In some embodiments, the directory service 126 may be part of the authorization service 116. In some embodiments, the directory service 126 may be separate from the authorization service 116. In various embodiments, the configuration service 114 may be communicatively coupled to the permissions modeling service 122. In various embodiments, the permissions modeling service 122 is configured to denormalize permissions data and transform the hierarchical relationships into a format that allows for efficient querying and evaluation of the permissions data. For example, the permissions modeling service 122 may be configure apply one or more transformation algorithms to permissions data associated with one or more resources and transform the hierarchical relationships thereof into format allows for efficient querying and evaluation of the permissions data. In some embodiments, denormalizing the permissions data comprise introducing redundancy within the database storing the permissions data to, for example, improve query performance.

In various embodiments, the access control and management computing device 106 includes an event processing service 112. In various embodiments, the event processing service 112 is configured to facilitate event-driven architecture associated with the access control and management system 101. In various embodiments, the event processing service 112 is configured to receive event objects (e.g., events) associated with a hierarchical resource structure and/or permissions stored in a permissions repository 110 and send the received event objects to the access control and management computing device 106 (e.g., to the authorization service 116 and/or other components thereof).

In various embodiments, the access control and management system 101 includes a storage subsystem 108. In various embodiments, the storage subsystem 108 is embodied by the access control and management computing device 106. The storage subsystem 108 may be configured to store input data, training data, and/or the like that may be used by the access control and management system 101 to perform various functionalities associated therewith. The storage subsystem 108 may be configured to store (e.g., persistently store and/or the like) permissions data, hierarchical resource structures (or data representative of hierarchical resource structures) and/or associated hierarchical resource definition structures (or data representative of the hierarchical resource definition structure).

In some embodiments, the storage subsystem 108 may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. Additionally, the storage subsystem 108 may be configured to store one or more artificial intelligence/machine learning models.

In some embodiments, the storage subsystem 108 is configured to store one or more components of the access control and management system 101. As shown in FIG. 1, the storage subsystem 108 may include a permissions repository 110 and/or other repositories. As described above, in various embodiments, the permissions repository 110 is configured to store permission data associated with one or more resources in a denormalized structure. Additionally, in some embodiments, the permissions repository 110 is configured to store hierarchical resource structures (or data representative of hierarchical resource structures) and/or associated hierarchical resource definition structures (or data representative of the hierarchical resource definition structure). In some embodiments, the permissions repository 110 and/or the storage subsystem 108 is configured to permissions (e.g., permission sets, permission datasets, child permission subsets, or other similar terms used herein) persistently and in cache, allowing for quick access to frequently used permission information while ensuring data durability.

The components of the access control and management system 101 may be arranged in a distributed architecture. For example, the storage subsystem 108 and permissions repository 110 may provide centralized data storage capabilities while the various services handle different aspects of access control management and permissions processing. In some embodiments, the separation of the write request processing service 118 and the read request processing service 120 may allow for efficient handling of write and read operations respectively. This separation may enable the system 101 to optimize performance for different types of requests and manage resources effectively.

Two or more of the components illustrated in the system architecture 100 illustrated in FIG. 1 may be configured to communicate via one or more communication mechanisms, including wired or wireless connections, such as over a network 104, bus, or similar connection. A network 104 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited, to TCP/IP based networking protocols. In some embodiments, the protocol is a custom protocol of JavaScript Object Notation (JSON) objects sent via a WebSocket channel. In some embodiments, the protocol is JSON over RPC, JSON over REST/HTTP, and/or the like.

In some embodiments, the components depicted in FIG. 1, although not required to be an integral system, may be connected via one or more networks. In some embodiments, one or more APIs may be leveraged to communicate with and/or facilitate communication between one or more of the components illustrated in the system architecture 100.

### Example Apparatuses of the Disclosure

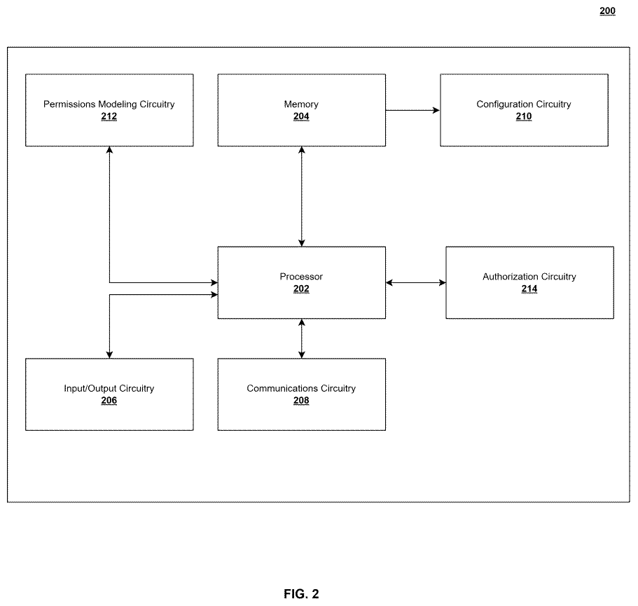

The example access control and management computing device 106 may be embodied by one or more computing systems, such as apparatus 200 (access control and management apparatus 200) shown in FIG. 2. It should be noted, however, that the components, or elements illustrated in and described with respect to FIG. 2 may not be mandatory and thus one or more may be omitted in certain embodiments. Additionally, some embodiments, may include further or different components or elements beyond those illustrated in and described with respect to FIG. 2. In some embodiments, the apparatus 200 may comprise one or a plurality of physical devices.

The apparatus 200 may include processor 202, memory 204, input/output circuitry 206, communications circuitry 208, configuration circuitry 210, permissions modeling circuitry 212, and/or authorization circuitry 214. The apparatus 200 may be configured to execute the operations described herein. Although these components 202-214 are described with respect to functional limitations, it should be understood that the particular implementations necessarily include the use of particular hardware. It should also be understood that certain of these components 202-214 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

Additionally, or alternatively, in some embodiments, two or more of the sets of circuitries embodying processor 202, memory 204, input/output circuitry 206, and/or communications circuitry 208 are combinable. Alternatively, or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208 are combined into a single module embodied in hardware, software, firmware, and/or a combination thereof. Similarly, in some embodiments, one or more of the sets of circuitry 202-214 is/are combined with the processor 202, such that the processor 202 performs one or more of the operations described above with respect to each of these sets of circuitry.

In some embodiments, the apparatus 200 may include a configuration circuitry 210 which may include hardware elements, with or without enabling software elements, firmware elements, or a combination thereof configured to, with the processor 202, input/output circuitry 206 or communications circuitry 208, perform one or more functions associated with the configuration service 114 (as described above with reference to FIG. 1). For example, the configuration circuitry 210 may access, facilitate access, receive, process, manipulate, provide, or otherwise use, or make available for use, certain data (e.g., permissions data, hierarchical resource structure and/or associated data, hierarchical role definition structures and/or associated data, or other data) used by one or more other elements of the apparatus 200 through, for example, the use of hardware, software, applications, or APIs executed using a processor, such as the processor 202. In some embodiments, the configuration circuitry 210 may interact with the memory 204, which may store the aforementioned data. It should also be appreciated that, in some embodiments, the configuration circuitry 210 may include a separate processor, specially configured field programmable gate array (FPGA), or application specific interface circuit (ASIC) to receive such data utilized by the configuration circuitry 210. The configuration circuitry 210 may also provide for communication with other elements of the apparatus 200, system or external systems via a network interface provided by the communications circuitry 208. In some embodiments, one or more portions of the configuration circuitry 210 and processor 202 may be integrated into a single circuitry or group of circuitries, with or without various other circuitries discussed herein, configured to execute the respective functionalities thereof.

In some embodiments, the apparatus 200 may include a permissions modeling circuitry 212 which may include hardware elements, with or without enabling software elements, firmware elements, or a combination thereof configured to, with the processor 202, input/output circuitry 206 or communications circuitry 208, perform one or more functions associated with the permissions modeling service 122 (as described above with reference to FIG. 1). For example, the permissions modeling circuitry 212 may access, facilitate access, receive, process, manipulate, provide, or otherwise use, or make available for use, certain data (e.g., permissions data, hierarchical resource structure and/or associated data, hierarchical role definition structures and/or associated data, or other data) used by one or more other elements of the apparatus 200 through, for example, the use of hardware, software, applications, or APIs executed using a processor, such as the processor 202. In some embodiments, the permissions modeling circuitry 212 may interact with the memory 204, which may store the aforementioned data. It should also be appreciated that, in some embodiments, the permissions modeling circuitry 212 may include a separate processor, specially configured field programmable gate array (FPGA), or application specific interface circuit (ASIC) to receive such data utilized by the permissions modeling circuitry 212. The permissions modeling circuitry 212 may also provide for communication with other elements of the apparatus 200, system or external systems via a network interface provided by the communications circuitry 208. In some embodiments, one or more portions of the permissions modeling circuitry 212 and processor 202 may be integrated into a single circuitry or group of circuitries, with or without various other circuitries discussed herein, configured to execute the respective functionalities thereof.

In some embodiments, the apparatus 200 may include an authorization circuitry 214 which may include hardware elements, with or without enabling software elements, firmware elements, or a combination thereof configured to, with the processor 202, input/output circuitry 206 or communications circuitry 208, perform one or more functions associated with the authorization service 116 (e.g., one or more function associated with the write request processing service 118 and read request processing service 120 as described above with reference to FIG. 1). For example, the authorization circuitry 214 may access, facilitate access, receive, process, manipulate, provide, or otherwise use, or make available for use, certain data (e.g., permissions data, hierarchical resource structure and/or associated data, hierarchical role definition structures and/or associated data, event data, or other data) used by one or more other elements of the apparatus 200 through, for example, the use of hardware, software, applications, or APIs executed using a processor, such as the processor 202. In some embodiments, the authorization circuitry 214 may interact with the memory 204, which may store the aforementioned data. It should also be appreciated that, in some embodiments, the authorization circuitry 214 may include a separate processor, specially configured field programmable gate array (FPGA), or application specific interface circuit (ASIC) to receive such data utilized by the authorization circuitry 214. The authorization circuitry 214 may also provide for communication with other elements of the apparatus 200, system or external systems via a network interface provided by the communications circuitry 208. In some embodiments, one or more portions of the authorization circuitry 214 and processor 202 may be integrated into a single circuitry or group of circuitries, with or without various other circuitries discussed herein, configured to execute the respective functionalities thereof. In some embodiments, the apparatus 200 may include an a directory circuitry, which may include hardware elements, with or without enabling software elements, firmware elements, or a combination thereof configured to, with the processor 202, input/output circuitry 206 or communications circuitry 208, perform one or more functions associated with the directory service 126.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

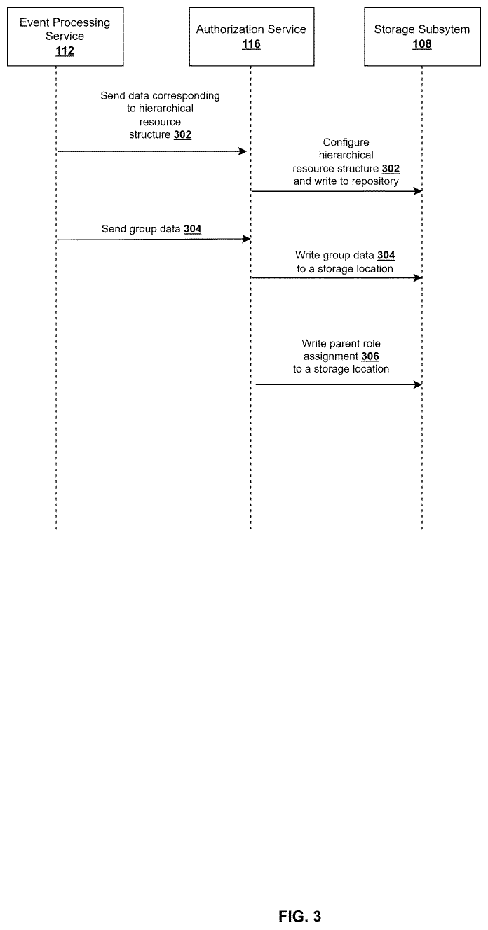

In some cases, the access control and management system 101 may be configured to process and configure hierarchical structures and associated data. FIG. 3 illustrates a sequence diagram depicting interactions between the event processing service 112, the authorization service 116, and the storage subsystem 108 for configuring hierarchical structures and associated data.

### Example Data Flows, Operations, and Operational Examples

FIG. 3 illustrates an example sequence diagram for configuring hierarchical resource structures and permissions in accordance with at least some embodiments of the present disclosure. As shown in FIG. 3, in some embodiments, the event processing service 112 sends data corresponding to a hierarchical resource structure 302 to the authorization service 116. For example, the event processing service may send a representation of a hierarchical resource structure 302. The event processing service 112 may receive the hierarchical resource structure 302 (e.g., data corresponding to the hierarchical resource structure), directly or indirectly from a client computing device 102. In some embodiments, the authorization service 116 may receive the hierarchical resource structure 302 from the event processing service via an API. The hierarchical resource structure 302 may represent relationships between resources associated with one or more applications. The hierarchical resource structure 302 may comprise a parent resource hierarchical level corresponding to a parent resource and one or more child resource hierarchical levels corresponding to one or more child resources. In some embodiments, the parent resource hierarchical level is the highest level in the hierarchical resource structure. In some embodiments, the hierarchical resource structure 302 may comprise multiple parent resources. In some embodiments, at least one child resource in the hierarchical resource structure 302 is directly associated with each of at least two parent resources (e.g., associated with the highest levels in the hierarchical resource structure). In some embodiments, at least two child resource may be directly associated with a parent resource. In some embodiments, at least one child resource in the hierarchical resource structure 302 may be directly associated with each of at least two child resources that are associated with a higher level in the hierarchical resource structure relative to the at least on child resource.

In some embodiments, the authorization service 116 may process the received data/hierarchical resource structure 302 and configure the hierarchical resource structure 302. In some embodiments, configuring the hierarchical resource structure 302 comprises whitelisting the hierarchical resource structure 302. In some embodiments, such whitelisting may include validating and approving the hierarchical resource structure 302 for use within the access control and management system 101. In some embodiments, configuring the hierarchical resource structure 302 comprises pre-processing the hierarchical resource structure 302 in a manner that enables the authorization service 116 to whitelist the hierarchical resource structure 302. In some embodiments, configuring the hierarchical resource structures ensures that valid hierarchical relationships are processed.

In some embodiments, configuring the hierarchical resource structure 302 comprises structuring and defining permissions and hierarchical resource definition structures. For example, the authorization service 116 may define a hierarchical role definition structure for the hierarchical resource structure 302 and associate the hierarchical role definition structure to the hierarchical resource structure 302. The hierarchical role definition structure may define one or more roles having a hierarchical relationship. For example, the hierarchical role definition structure may comprise a parent role hierarchical level associated with a parent role and one or more child role hierarchical levels associated with one or more child roles. The parent role may comprise or represent a parent role definition credential associated with particular permissions and each of the one or more child roles may comprise or represent a child role definition credential each associated with respective permissions. In various embodiments, the permissions associated with the parent role is different from the permissions associated with the child roles. In various embodiments, the respective permissions associated with the child roles comprise subsets of the permissions associated with the parent role.

In some embodiments, after configuring the hierarchical resource structure 302, the authorization service 116 stores the configured hierarchical resource structure 302 in a storage location such as storage subsystem 108. In some embodiments, the hierarchical resource structure 302 may be stored in a repository associated with the storage subsystem 108. In some embodiments, such repository may be a permissions repository such as permissions repository 110. In some embodiments, the hierarchical resource structure 302 may be stored in other repositories. In some embodiments, storing the hierarchical resource structure 302 in the storage location comprises performing a write operation using a write request processing service. In some embodiments, the authorization service 116 may leverage the write request processing service 118 or other write requesting processing service to write the hierarchical resource structure (e.g., underlying data thereof) to the storage location. In some embodiments, the hierarchical resource structure may be stored in the storage location along with the associated hierarchical role definition structure.

In some embodiments, event processing service 112 transmits group data 304 to the authorization service 116. The group data 304 may include information about user groups associated with the hierarchical resource structure 302 or parent resource thereof. In some embodiments, the group data 304 reflects membership of users to each of one or more user groups. For example, the group data 304 may represent an organizational structure (or portion thereof) that includes one or more groups of users. In some embodiments a group may be represented by a group identifier within the group data. Alternatively, or additionally, a user or user profile may be represented by a user identifier in the group data. In response to receiving the group data 304, the authorization service 116 stores the group data in a storage location such as storage subsystem 108. In some embodiments, the authorization service 116 may process the group data 304 before storing in the storage location. In some embodiments, the group data 304 may be stored in a repository associated with the storage subsystem 108. In some embodiments, such repository may be a permissions repository such as permissions repository 110. In some embodiments, the group data 304 may be stored in other repositories. In some embodiments, storing the group data 304 in the storage location comprises performing a write operation using a write request processing service. In some embodiments, the authorization service 116 may leverage the write request processing service 118 or other write requesting processing service to write the group data 304 to the storage location.

In some embodiments, the authorization service 116 writes a parent role assignment 306 to the permissions repository 110 in the storage subsystem 108. In some embodiments, the parent role assignment 306 may be stored in other repositories. In some embodiments, the parent role assignment 306 comprises data indicative and/or representative of association of a particular role (e.g., parent role in the hierarchical role definition structure) to the parent resource in the hierarchical parent resource structure.

In some embodiments, the access control and management system 101 utilizes a pre-defined schema for processing resource hierarchy events. This pre-defined schema may define the structure and format of the data received by the event processing service 112 and processed by the authorization service 116. The use of a pre-defined schema may enable consistent and efficient handling of resource hierarchy data across different components of the access control and management system 101.

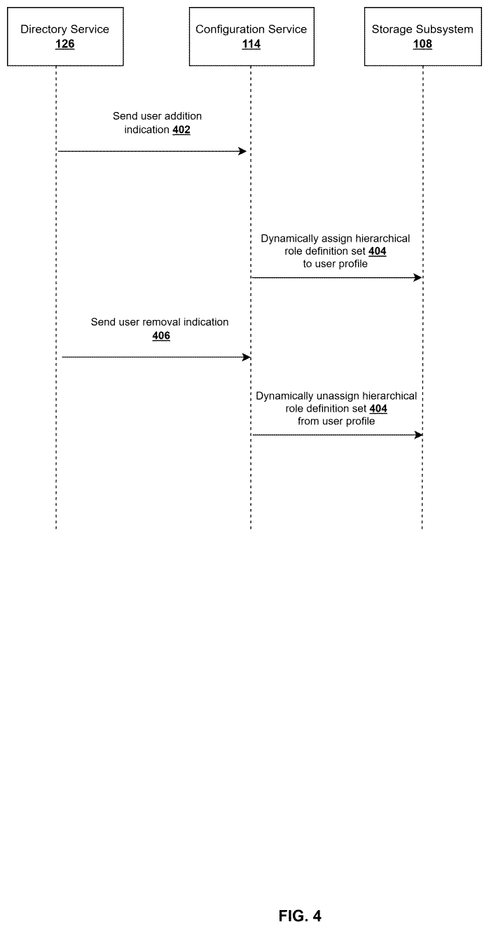

FIG. 4 illustrates a sequence diagram 400 for managing user additions and removals in an access control and management system in accordance with at least some embodiments of the present disclosure. In particular, FIG. 4 depicts interactions between a directory service 126, a configuration service 114, and/or an authorization service 116 for managing user group memberships and associated permissions. The sequence diagram 400 shows processes for user addition and removal within the access control and management system 101.

In some embodiments, the directory service 126 identifies a user addition event. In some embodiments, identifying a user addition event comprises receiving the user addition event or user addition indication 402 from a client computing device 102. In some embodiments, the directory service 126 may receive a user addition event and generate a user addition indication 402 in response to receiving the user addition event. The user addition event may be representative and/or indicative of the addition of a user to a group. For example, the user addition indication 402 may be correlated to a group associated with a parent resource in a hierarchical resource structure. The user addition event and/or user addition indication 402 may identify or otherwise comprise a user identifier corresponding to the user and a group identifier corresponding to the group. In some embodiments, the directory service 126 transmits the user addition indication 402 to the configuration service 114 for processing. In some embodiments, the directory service 126 may transmit the user addition indication 402 to the authorization service 116 for processing.

In some embodiments, upon receiving the user addition indication 402, the configuration service 114 (or authorization service 116) processes the user addition indication 402. In some embodiments, processing the user addition indication 402 comprises dynamically assigning a hierarchical role definition set 404 to a user profile corresponding to the user identifier in the user addition indication 402. The configuration service 114 (or authorization service 116) may determine the hierarchical role definition set 404 based on the hierarchical resource structure and a permissions set associated with the parent resource. For example, the configuration service 114 (or authorization service 116) may query the permissions repository 110 to determine the roles and permissions to assign to the user profile based on the parent role assignment 306 within the permissions repository 110. As described above, the parent role assignment 306 may comprise a group identifier, a parent resource identifier, and assigned role associated with the parent resource identified by the parent resource identifier. For example, in some embodiments, querying the permissions repository 110 to dynamically assign a hierarchical definition set 404 to a user profile comprises mapping the group identifier in the user addition indication 402 to a parent role assignment 306 in the permissions repository 110 that includes the group identifier to identify the corresponding hierarchical role definition structure (e.g., comprising the hierarchical definition set 404).

In some embodiments, the hierarchical role definition set 404 comprises dynamic role definition credentials for the user associated with the user profile for each of the parent resource and one or more child resources in the identifier hierarchical resource structure. In some embodiments, the role definition credential for the parent resource is associated with the permissions set associated with the parent resource and each of the dynamic role definition credentials for the one or more child resources is associated with a child permissions subset selected from the permissions set. In some embodiments, dynamically assigning the hierarchical definition set 404 comprises writing the user addition event to the storage subsystem 108 or permissions repository 110 thereof such that assignment of the hierarchical role definition set 404 is reflected in the system 101.

As described above, the sequence diagram 400 illustrates a process for handling user removal from a group. In some embodiments, the directory service 126 may identify a user removal event. In some embodiments, identifying a user removal event comprises receiving the user removal event or user removal indication 406 from a client computing device 102. In some embodiments, the directory service 126 may receive a user removal event and generate a user removal indication 406 in response to receiving the user removal event. The user removal event may be representative and/or indicative of the removal of a user from a group. For example, the user removal indication 406 may be correlated to a group associated with a parent resource in a hierarchical resource structure. The user removal event and/or user removal indication 406 may identify or otherwise comprise a user identifier corresponding to the user and a group identifier corresponding to the group. In some embodiments, the directory service 126 transmits the user removal indication 406 to the configuration service 114 for processing. In some embodiments, the directory service 126 may transmit the user removal indication 406 to the authorization service 116 for processing.

In some embodiments, upon receiving the user removal indication 406, the configuration service 114 (or authorization service 116) processes the user removal indication 406. In some embodiments, processing the user removal indication 406 comprises dynamically unassigning a hierarchical role definition set 404 previously assigned to a user profile corresponding to the user identifier in the user removal indication 406 to invalidated related permissions across the hierarchy that was previously granted to the user. The configuration service 114 (or authorization service 116) may determine the hierarchical role definition set 404 as described above. For example, the configuration service 114 (or authorization service 116) may query the permissions repository 110 to determine the hierarchical role definition set to unassign (e.g., revoke, invalidate, or similar terms) based on the parent role assignment 306 within the permissions repository 110. For example, in some embodiments, querying the permissions repository 110 to dynamically unassign a hierarchical definition set 404 previously assigned to a user profile comprises mapping the group identifier in the user removal indication 406 to a parent role assignment 306 in the permissions repository 110 that includes the group identifier to identify the corresponding hierarchical role definition structure (e.g., comprising the hierarchical definition set 404). The configuration service 114 (or authorization service 116) may then unassign the hierarchical role definition set 404 identified for the group identifier. This unassignment, in turn, revokes permissions associated with the hierarchical role definition set 404. In some embodiments, dynamically unassigning the hierarchical definition set 404 comprises writing the user removal event to the storage subsystem 108 or permissions repository 110 thereof such that unassignment of the hierarchical role definition set 404 is reflected in the system 101.

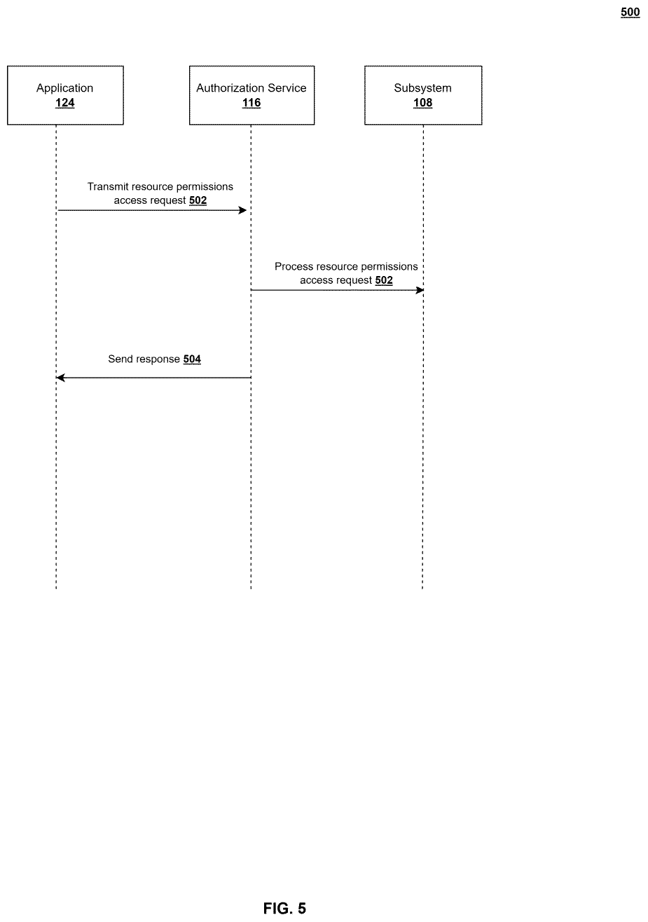

FIG. 5 illustrates a sequence diagram for handling resource permissions access requests in accordance with at least some embodiments of the present disclosure. In some embodiments, an application 124 or a client computing device 102 may transmit a resource permissions access request 502 to the authorization service 116. In some embodiments, the resource permissions access request 502 may be associated with a user profile. The resource permissions access request 502 may comprise a user identifier, a resource identifier, and a permissions type (e.g., corresponding to a resource with respect to which access is requested).

In some embodiments, in response to receiving the resource permissions access request 502, the authorization service 116 processes the resource permissions access request 502 to determine if the user profile/user associated with the user identifier possesses the requisite permissions for accessing the resource corresponding to the resource identifier. In some embodiments, processing the resource permissions access request 502 comprise querying the permissions repository 110 in the storage subsystem 108 for permissions associated with the user profile for the resource corresponding to the resource identifier. In some embodiments, querying the resource permissions repository for permissions associated with the user profile for the resource comprises identifying group(s) associated with the user based on the user identifier, identifying and/or retrieving hierarchical role definition structure(s) associated with the identified group(s) based on respective corresponding group identifiers, and evaluating the hierarchical role definition structure(s) to determine if the associated permissions satisfy the requisite permissions for accessing the resource corresponding to the resource identifier. In some embodiments, the authorization service 116 may leverage the read request processing service 120 to process the resource permissions access request 502.

In some embodiments, in response to processing the resource permissions access request 502, the authorization service 116 generate and provides a response 504 to the resource permissions access request 502 based on the determination of whether the user profile possesses the requisite permissions. For example, the authorization service may transmit computer-executable instructions configured to cause the response 504 to be transmitted to the application 124 or client computing device 102 regarding the resource permissions access request 502. In some embodiments, the authorization service 116 may leverage one or more of the components of the access control and management computing device 106 to generate the response 504.

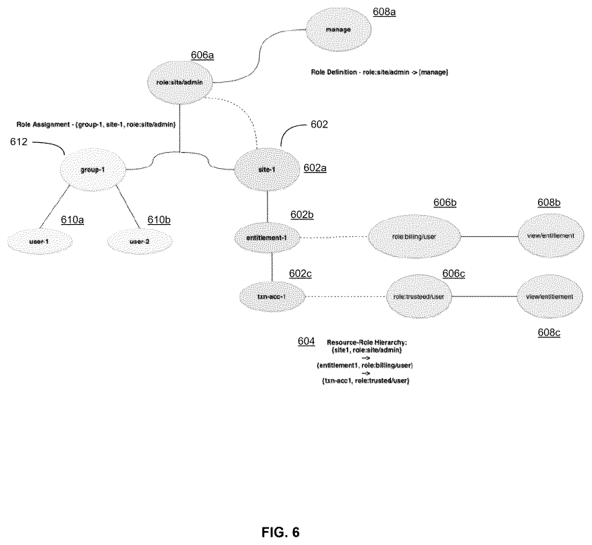

FIG. 6 illustrates an operational example of a hierarchical resource structure with associated hierarchical role definition structure and permissions in accordance with at least some embodiments of the present disclosure. In the illustrated operational example of FIG. 6, the hierarchical resource structure 602 comprises a first parent resource hierarchical level and two child resource hierarchical levels. In the illustrated operational example of FIG. 6, the hierarchical resource structure 602 comprises a site resource 602a at the top level, which may correspond to a first parent resource hierarchical level. The site resource 602a may be associated with a permissions set. The hierarchical resource structure 602 further includes an entitlement resource 602b at a middle level and a transaction account resource 602c at a bottom level, which may correspond to one or more child resource hierarchical levels.

In the illustrated operational example of FIG. 6, a hierarchical role definition structure 604 may be defined based on the hierarchical resource structure 602. The hierarchical role definition structure 604 comprises role definition credentials 606a-c associated with each level of the hierarchical resource structure 602. In the illustrated operational example of FIG. 6, a site admin role 606a is associated with the site resource 602a and may be associated with a manage permission 608a. The site admin role 606a may represent a parent role definition credential that is different from dynamic role definition credentials associated with child resources.

In the illustrated operational example of FIG. 6, a billing user role 606b is associated with the entitlement resource 602b and is associated with a view entitlement permission 608b. In the illustrated operational example of FIG. 6, a trusted user role 606c is associated with the transaction account resource 602c and is associated with a view entitlement permission 608c. The billing user role 606b and trusted user role 606c may represent dynamic role definition credentials for the child resources.

The parent role definition credential (e.g., site admin role 606a) may be associated with permissions data from the permissions set that is different from child permissions subsets associated with each of the dynamic role definition credentials (e.g., the billing user role 606b and trusted user role 606c). Each dynamic role definition credential may be associated with a child permissions subset selected from the permissions set associated with the site resource 602a. The hierarchical role definition structure 604 may define a hierarchical role structure associated with the hierarchical resource structure 602. The hierarchical role structure may comprise a parent role hierarchical level associated with the parent role definition credential (e.g., site admin role 606a) and one or more child role hierarchical levels associated with the dynamic role definition credentials (e.g., billing user role 606b and trusted user role 606c).

In the illustrated operational example of FIG. 6, the site resource 602a may correspond to a first software application associated with a multi-layer service-oriented platform. The entitlement resource 602b and transaction account resource 602c may represent child resources associated with the first software application. In the illustrated operational example of FIG. 6. a group 612 may be defined within the hierarchical resource structure 602. The group 612 may contain a first user 610a and a second user 610b. The group 612 may be associated with the site resource 602a through a role assignment relationship. The hierarchical role definition structure 604 may indicate that the site admin role 606a flows to the billing user role 606b, which flows to the trusted user role 606c. This structure may allow for inheritance of permissions from higher levels to lower levels in the hierarchy.

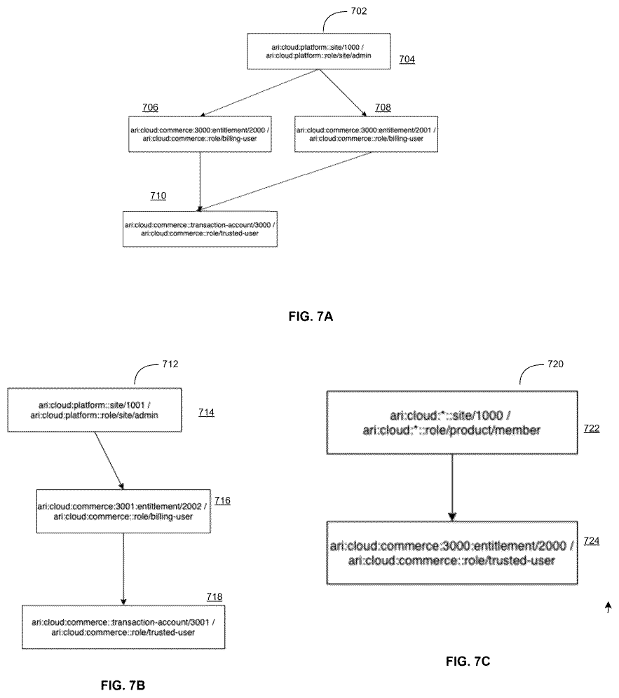

FIGS. 7A-7C illustrate block diagrams of various hierarchical role definition structures in accordance with at least some embodiments of the present disclosure. FIG. 7A shows a hierarchical role definition structure 702 comprising a parent resource role 704 at the top level. The parent resource role 704 is associated with role definition credentials 704-710. In the illustrated operational example of FIG. 7A, the parent resource role 704 connects to a first child resource role 706 and a second child resource role 708. The first child resource role 706 and the second child resource role 708 may represent different child resource hierarchical levels within the hierarchical role definition structure 702. Both the first child resource role 706 and the second child resource role 708 connects to a transaction account role 710 at the bottom level of the hierarchy. In the illustrated operational example of FIG. 7A, the first child resource role 706 is associated with a first role definition credential from the role definition credentials 704-710, while the second child resource role 708 is associated with a second role definition credential from the role definition credentials 704-710. The first role definition credential may be different from the second role definition credential, allowing for distinct permissions or access rights to be assigned to each child resource role.

FIG. 7B depicts a hierarchical role definition structure 712 with a parent resource role 714 at the top level. The parent resource role 714 may be associated with role definition credentials 714-718. In the illustrated operational example of FIG. 7B, the parent resource role 714 connects to a child resource role 716, which in turn connects to a transaction account role 718, forming a linear hierarchical chain.

FIG. 7C shows a hierarchical role definition structure 720 with a parent resource role 722 at the top level. The parent resource role 722 is associated with role definition credentials 722-724. In the illustrated operational example of FIG. 7C, the parent resource role 722 connects directly to a child resource role 724, representing a two-level hierarchical relationship.

The hierarchical role definition structures shown in FIGS. 7A-7C may illustrate different configurations of role relationships between parent resources, and child resources. These hierarchical structures may demonstrate how roles can be organized in various hierarchical arrangements, from multi-branch hierarchies to linear chains to simple parent-child relationships. The flexibility demonstrated by these different hierarchical role definition structures may allow the access control and management system 101 to adapt to various organizational structures and permission requirements.

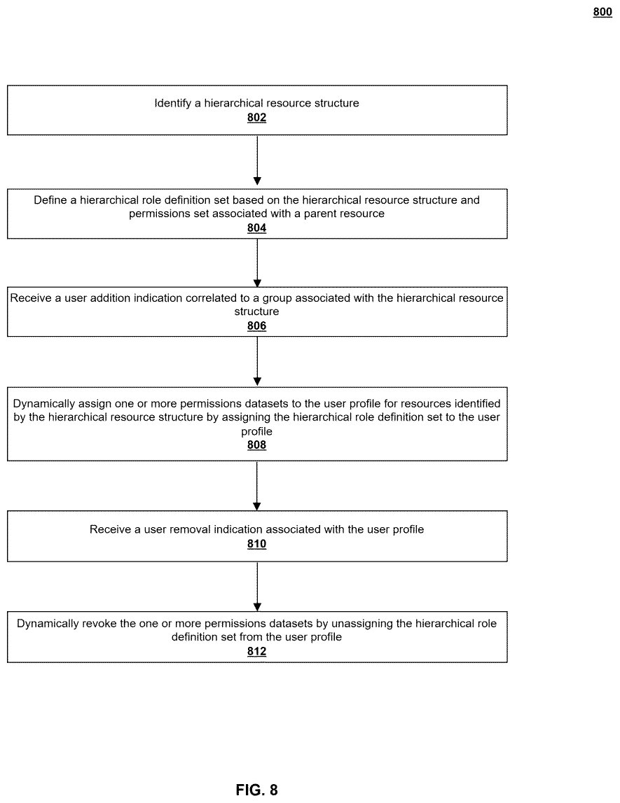

FIG. 8 illustrates a flowchart of an example process 800 for configuring and managing hierarchical resource permissions in accordance with at least some embodiments of the present disclosure. The process 800 may be implemented by one or more computing devices, apparatuses, entities, and/or systems described herein. For example, the process 800 may be a computer-implemented method. FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes at step/operation 802, identifying a hierarchical resource structure. The hierarchical resource structure may comprise a first parent resource hierarchical level corresponding to a first parent resource and one or more child resource hierarchical levels corresponding to one or more child resources. In some embodiments, identifying the hierarchical resource structure comprises receiving the hierarchical resource structure via an API. Alternatively, or additionally, in some embodiments, identifying the hierarchical resource structure comprises receiving the hierarchical resource structure via a message queue.

In some embodiments, the first parent resource may be associated with a permissions set. In some embodiments, the first parent resource corresponds to a first software application associated with the multi-layer service-oriented platform. In some embodiments, the permissions set is stored in a permissions repository using a denormalized architecture. This denormalized architecture may allow for efficient retrieval and evaluation of permissions data, potentially improving the performance of the access control and management system 101 when handling resource access permissions requests.

In some embodiments, the process 800 includes at step/operation 804, defining a hierarchical role definition set based on the hierarchical resource structure and the permissions set associated with the parent resource. In some embodiments, the hierarchical role definition set further comprises a parent role definition credential that is different from the dynamic role definition credentials. In some embodiments, the parent role definition credential is associated with permissions data from the permissions set that is different from the child permissions subset for each of the dynamic role definition credentials.

In some embodiments, the one or more child resource hierarchical levels comprise a first child hierarchical level corresponding to a first child resource of the one or more child resources and a second child hierarchical level corresponding to a second child resource of the one or more child resources. In some embodiments, the first child resource is associated with a first role definition credential from the dynamic role definition credentials and the second child resource is associated with a second role definition credential from the dynamic role definition credentials. In some embodiments, the first role definition credential is different from the second role definition credential.

In some embodiments, the parent role definition credential and the dynamic role definition credentials define a hierarchical role structure associated with the hierarchical resource structure. In some embodiments, the hierarchical role structure comprises a parent role hierarchical level associated with the parent role definition credential and one or more child role hierarchical levels associated with the dynamic role definition credentials.

In some embodiments, the process 800 includes at step/operation 806, receiving a user addition indication correlated to a group associated with the hierarchical resource structure. The user addition indication may be associated with a user profile.

In some embodiments, the process 800 includes at step/operation 808, dynamically assigning one or more permissions datasets to the user profile for resources identified by the hierarchical resource structure.

In some embodiments, the process 800 includes at step/operation 810, removing a user removal indication associated with the user profile.

In some embodiments, the process 800 includes at step/operation 812, dynamically revoking the one or more permissions datasets are by unassigning the hierarchical role definition set from the user profile.

In some embodiments, the process 800 may include additional operations. For example, the access control and management system 101 may receive a change event indication correlated to the hierarchical resource structure. In response to this change event indication, the system may dynamically update the hierarchical resource structure. Additionally, the system may dynamically update the hierarchical role definition set associated with the user profile based on the change event indication.

In some embodiments, the access control and management system 101 may receive user removal indication correlated to the group, wherein the user removal indication is associated with the user profile. In some embodiments, in response to the user removal indication, the access control and management system 101 may dynamically unassign the hierarchical role definition set from the user profile to revoke the child permissions subset associated with the user profile.

The access control and management system 101 may support both live event ingestion and bootstrap event ingestion for resource hierarchies. Live event ingestion may allow for real-time updates to the hierarchical resource structure and associated permissions, while bootstrap event ingestion may enable bulk loading of hierarchical resource data during system initialization or data migration processes.

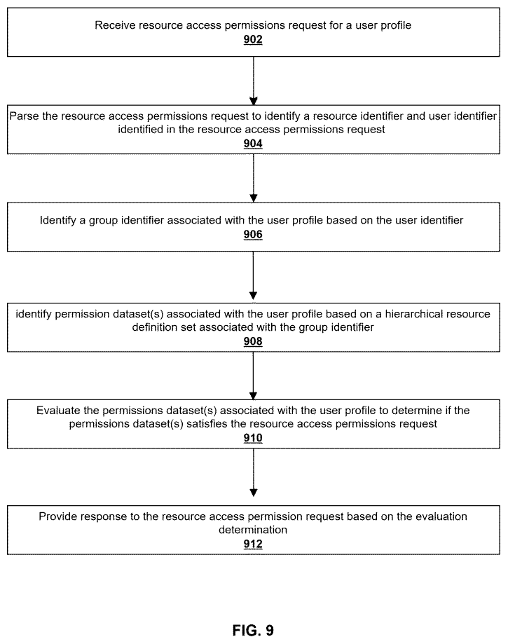

FIG. 9 illustrates a flowchart of a process 900 for handling resource access permissions requests in accordance with at least some embodiments of the present disclosure. The process 900 may be implemented by one or more computing devices, apparatuses, entities, and/or systems described herein. For example, the process 900 may be a computer-implemented method. FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 includes at step/operation 902, receiving a resource access permissions request for a user profile. In some embodiments, the resource access permission request comprises a user identifier, resource identifier, and permissions type.

In some embodiments, the process 900 includes at step/operation 904, parsing the resource access permissions request to identify a resource identifier and user identifier identified in the resource access permissions request. In some example, the resource identifier may be used to query a permissions repository. For example, in some embodiments, a permissions repository may be queried for permissions associated with the user for a target resource identified by the resource identifier.

In some embodiments, the process 900 includes at step/operation 906, identifying a group identifier associated with the user profile based on the user identifier.

In some embodiments, the process 900 includes at step/operation 908, identifying permission dataset(s) associated with the user profile based on a hierarchical resource definition set associated with the group identifier.

In some embodiments, the process 900 includes at step/operation 910, evaluating the permissions dataset(s) associated with the user profile to determine if the permissions dataset(s) satisfies the resource access permissions request. For example, evaluating the permissions dataset(s) may comprise comparing the requested access permissions with the permissions associated with the user profile for the identified resource.

In some embodiments, the process 900 includes at step/operation 912, providing a response to the resource access permission request based on the evaluation determination.

In some cases, the access control and management system 101 may use a Last-Write-Wins (LWW) conflict resolution strategy for handling out-of-order events. This strategy may help ensure consistency in the permissions data when processing multiple events or requests that may arrive in a non-sequential order. The LWW strategy may be particularly useful in distributed systems where network latency or other factors could lead to events being processed out of their original sequence.

By implementing this process 900, the access control and management system 101 may efficiently handle resource access permissions requests while leveraging the hierarchical resource structures and role definition sets to determine appropriate access rights for users across various resources and applications.

A number of implementations have been described. Nevertheless, it will be understood that various modifications may be made without departing from the spirit and scope of the disclosure. Accordingly, other implementations are within the scope of the following claims.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### Conclusion

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for configuring a hierarchical delegated permission modeling framework in a multi-layer service-oriented platform, the computer-implemented method comprising:
identifying a hierarchical resource structure comprising a first parent resource hierarchical level corresponding to a first parent resource and one or more child resource hierarchical levels corresponding to one or more child resources, wherein the first parent resource is associated with a permissions set;
receiving a user addition indication correlated to a group associated with the first parent resource, wherein the user addition indication is associated with a user profile; and
dynamically assigning a hierarchical role definition set to the user profile based on the hierarchical resource structure and permissions set in response to the user addition indication, wherein the hierarchical role definition set comprises dynamic role definition credentials for a user associated with the user profile for each of the one or more child resources, and wherein each of the dynamic role definition credentials is associated with a child permissions subset selected from the permissions set.

2. The computer-implemented method of claim 1, wherein the hierarchical role definition set further comprises a parent role definition credential that is different from the dynamic role definition credentials, and wherein the parent role definition credential is associated with permissions data from the permissions set that is different from the child permissions subset for each of the dynamic role definition credentials.

3. The computer-implemented method of claim 2, wherein the parent role definition credential and the dynamic role definition credentials define a hierarchical role structure associated with the hierarchical resource structure, wherein the hierarchical role structure comprises (i) a parent role hierarchical level associated with the parent role definition credential and (ii) one or more child role hierarchical levels associated with the dynamic role definition credentials.

4. The computer-implemented method of claim 1, wherein the first parent resource corresponds to a first software application associated with the multi-layer service-oriented platform.

5. The computer-implemented method of claim 1, wherein the one or more child resource hierarchical levels comprise (i) a first child hierarchical level corresponding to a first child resource of the one or more child resources and (ii) a second child hierarchical level corresponding to a second child resource of the one or more child resources, wherein the first child resource is associated with a first role definition credential from the dynamic role definition credentials and the second child resource is associated with a second role definition credential from the dynamic role definition credentials, and wherein the first role definition credential is different from the second role definition credential.

6. The computer-implemented method of claim 1, further comprising:
receiving user removal indication correlated to the group, wherein the user removal indication is associated with the user profile; and
in response to the user removal indication, dynamically unassigning the hierarchical role definition set from the user profile to revoke the child permissions subset associated with the user profile.

7. The computer-implemented method of claim 1, further comprising:
receiving a change event indication correlated to the hierarchical resource structure; and
dynamically updating the hierarchical resource structure in response to the change event indication.

8. The computer-implemented method of claim 7, further comprising:
dynamically updating the hierarchical role definition set associated with the user profile based on the change event indication.

9. The computer-implemented method of claim 1, wherein the permissions set is stored in a permissions repository using a denormalized architecture.

10. The computer-implemented method of claim 9, further comprising:
receiving a resource access permission request associated with the user profile, wherein the resource access permission request comprises a user identifier, resource identifier, and permissions type; and
processing the resource access permission request at least in part by querying the permissions repository for permissions associated with the user for a target resource identified by the resource identifier.

11. The computer-implemented method of claim 1, wherein identifying the hierarchical resource structure comprises receiving the hierarchical resource structure via an API.

12. The computer-implemented method of claim 1, further comprising:
in response to identifying the hierarchical resource structure, configuring the hierarchical resource structure to whitelist the hierarchical resource structure.

13. An apparatus for configuring a hierarchical delegated permission modeling framework in a multi-layer service-oriented platform, the apparatus comprising at least one processor and at least one memory including program code, the at least one memory and the program code configured to, with the at least one processor, cause the apparatus to at least:
identify a hierarchical resource structure comprising a first parent resource hierarchical level corresponding to a first parent resource and one or more child resource hierarchical levels corresponding to one or more child resources, wherein the first parent resource is associated with a group and a parent role definition credential, wherein the parent role definition credential is associated with a permissions set;
receive a user addition indication correlated to the group associated with the first parent resource, wherein the user addition indication is associated with a user profile; and
dynamically assign a hierarchical role definition set to the user profile based on the hierarchical resource structure and permissions set in response to the user addition indication, wherein the hierarchical role definition set comprises dynamic role definition credentials for a user associated with the user profile for each of the one or more child resources, and wherein each of the dynamic role definition credentials is associated with a child permissions subset that is different from the permissions set.

14. The apparatus of claim 13, wherein the parent role definition credential and the dynamic role definition credentials define a hierarchical role structure associated with the hierarchical resource structure, wherein the hierarchical role structure comprises (i) a parent role hierarchical level associated with the parent role definition credential and (ii) one or more child role hierarchical levels associated with the dynamic role definition credentials.

15. The apparatus of claim 13, wherein the first parent resource corresponds to a first software application associated with the multi-layer service-oriented platform.

16. The apparatus of claim 13, wherein the one or more child resource hierarchical levels comprise (i) a first child hierarchical level corresponding to a first child resource of the one or more child resources and (ii) a second child hierarchical level corresponding to a second child resource of the one or more child resources, wherein the first child resource is associated with a first role definition credential from the dynamic role definition credentials and the second child resource is associated with a second role definition credential from the dynamic role definition credentials, and wherein the first role definition credential is different from the second role definition credential.

17. The apparatus of claim 13, wherein the at least one memory and the program code configured to, with the at least one processor, further cause the apparatus to at least:
receive user removal indication correlated to the group, wherein the user removal indication is associated with the user profile; and
in response to the user removal indication, dynamically unassigning the hierarchical role definition set from the user profile to revoke the child permissions subset associated with the user profile.

18. The apparatus of claim 13, wherein the at least one memory and the program code configured to, with the at least one processor, further cause the apparatus to at least:
receive a change event indication correlated to the hierarchical resource structure; and
dynamically update the hierarchical resource structure in response to the change event indication.

19. The apparatus of claim 18, wherein the at least one memory and the program code configured to, with the at least one processor, further cause the apparatus to at least:
dynamically update the hierarchical role definition set associated with the user profile based on the change event indication.

20. At least one non-transitory computer-readable storage medium configuring a hierarchical delegated permission modeling framework in a multi-layer service-oriented platform, the at least one non-transitory computer-readable storage medium having computer coded instructions configured to, when executed by at least one processor:
identify a hierarchical resource structure comprising a first parent resource hierarchical level corresponding to a first parent resource and one or more child resource hierarchical levels corresponding to one or more child resources, wherein the first parent resource corresponds to a software application associated with the multi-layer service-oriented platform and is associated with a permissions set;
receive a user addition indication correlated to a group associated with the first parent resource, wherein the user addition indication is associated with a user profile; and
dynamically assign a hierarchical role definition set to the user profile based on the hierarchical resource structure and permissions set in response to the user addition indication, wherein the hierarchical role definition set comprises parent role definition credential for a user associated with the user profile for the first parent resource and dynamic role definition credentials for each of the one or more child resources, and wherein each of the dynamic role definition credentials is associated with a child permissions subset selected from the permissions set.
